(19) United States
(12) Patent Application Publication
(10) Pub. No.: US 2004/0229564 A1
(43) Pub. Date: Nov. 18, 2004

(54) GPS POSITIONER HAVING A RESCUE CALL FUNCTION AND THE SYSTEM THEREOF

(75) Inventors: Melvin Huang, Banciao City (TW); Kimber Wang, Su-Ao Township (TW); Kyle Chang, Banciao City (TW); Wei-Wen Kao, Taipei City (TW)

Correspondence Address: CONNOLLY BOVE LODGE & HUTZ LLP, SUITE 800, 1990 M STREET NW, WASHINGTON, DC, 20036-3425, US

(73) Assignee: LEADTEK RESEARCH INC., Taipei Hsien (TW)

(21) Appl. No.: 10/708,289

(22) Filed: Feb. 23, 2004

(30) Foreign Application Priority Data
May 14, 2003 (TW) 092113081

(51) Int. Cl. H04B 7/00

(52) U.S. Cl. 455/41.2

(57) ABSTRACT

A GPS positioner has a rescue call function by integrating a Bluetooth communication interface with the GPS positioner. Given the Bluetooth communication interface, not only may data transmission take place between the GPS positioner and a device having a Bluetooth communication interface as well, but also a rescue call may be sent through the device. The present invention enables the use of a smart phone having a Bluetooth communication interface, so that the smart phone may function as a device for seeking appropriate assistance by sending a rescue request in the form of a message or dialing.

### BACKGROUND OF THE INVENTION

1. Field of the Invention

The present invention relates to a GPS positioner having a rescue call function and an applied system thereof, and more particularly to a positioner that can send rescue request messages automatically.

2. Description of the Related Art

Since the United States opened up its global positioning system (GPS) to the international community in 1985, the navigation function of such a system has been widely applied to various fields like marine, aviation, salvage, engineering, geophysics, warfare, military drills, etc. Afterward, the selective availability (SA) effect was also closed so as to increase the standard precision of positioning from 100 meters to 20 meters, making it feasible to apply the global positioning system to vehicular navigation positioners. It is possible that the functions of the GPS positioners will be incorporated or integrated into cellular phones so that future cellular phones will be in wider use and, in consequence, future cellular phones will be more versatile.

Nevertheless, it is rather difficult to integrate GPS positioners nowadays with the wireless communications systems (e.g., GSM) of cellular phones, as the requisite integration entails a conversion interface. For instance, it is necessary to additionally equip a GPS positioner with a wireless communications module and a phone number in order to add an emergency rescue call function to the GPS positioner. Given the limits of their software, the known GPS positioners merely send messages or allow dialing at fixed phone numbers. It will be a much more demanding task to design the software required for GPS positioners in order to gain access to the other functions of the wireless communications module, for example, pressing keys, dialing, receiving a call, etc. Even worse, a special phone number and a communications module must not be used separately, otherwise flexibility of use and cost competitiveness will diminish.

Lately, some manufacturers have put GPS positioners 11 equipped with Bluetooth communication interfaces on the market (as shown in FIG. 1). Given the transmission method of the Bluetooth communications protocol 15, it is feasible to browse and find out a present location with a personal digital assistant (PDA), a notebook 14 or a smart phone 13 also having a Bluetooth communication interface. Although conventional technology involves using a Bluetooth communication interface instead of wireless communications, it enables users to read maps and find out their whereabouts with a GPS positioner 11 rather than gain access to the other functions of a browser, for example, pressing keys, dialing and sending message, not to mention sending rescue request messages automatically.

In short, there are urgent demands for GPS positioners having the function of sending rescue request messages automatically to solve the aforesaid problems.

### SUMMARY OF THE INVENTION

The first objective of the present invention is to provide a GPS positioner having a function of sending rescue request messages automatically and an applied system thereof, wherein bi-directional transmission takes place between a Bluetooth communication interface and a device having a similar communication interface, whereas rescue request messages are sent through the device with a Bluetooth communication interface.

The second objective of the present invention is to provide a GPS positioner which is flexible and an applied system thereof, whereby rescue request messages are transmitted without any special wireless communications phone number.

In order to achieve the objectives, the present invention discloses a GPS positioner having a rescue call function and an applied system thereof, by integrating a Bluetooth communication interface with the GPS positioner. Given the Bluetooth communication interface, not only may data transmission take place between the GPS positioner and a device having a Bluetooth communication interface as well, but also a rescue call may be sent through the device. The present invention enables the use of a smart phone having a Bluetooth communication interface, so that the smart phone may function as a device for seeking appropriate assistance by sending a rescue request in the form of a message or dialing.

### BRIEF DESCRIPTION OF THE DRAWINGS

The invention will be described according to the appended drawings in which:

FIG. 1 is a schematic diagram of the application of a conventional GPS positioner;

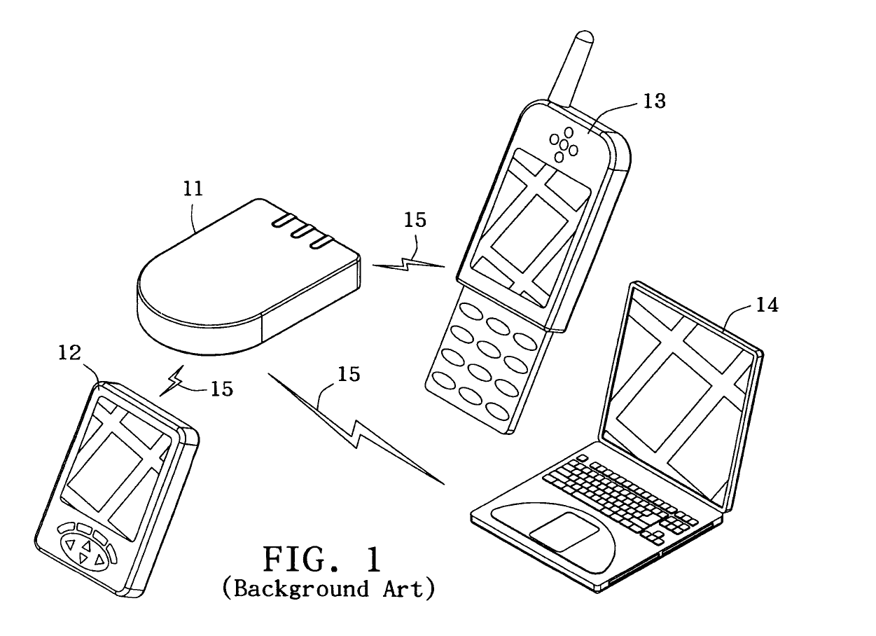

FIG. 2 is a schematic diagram of the application of a GPS positioner and its applied system in accordance with the present invention;

FIG. 3 is the functional block diagram of the hardware in accordance with the GPS positioner of the present invention; and

FIG. 4 is a flowchart of Bluetooth communications match for a GPS positioner in accordance with the present invention.

### PREFERRED EMBODIMENT OF THE PRESENT INVENTION

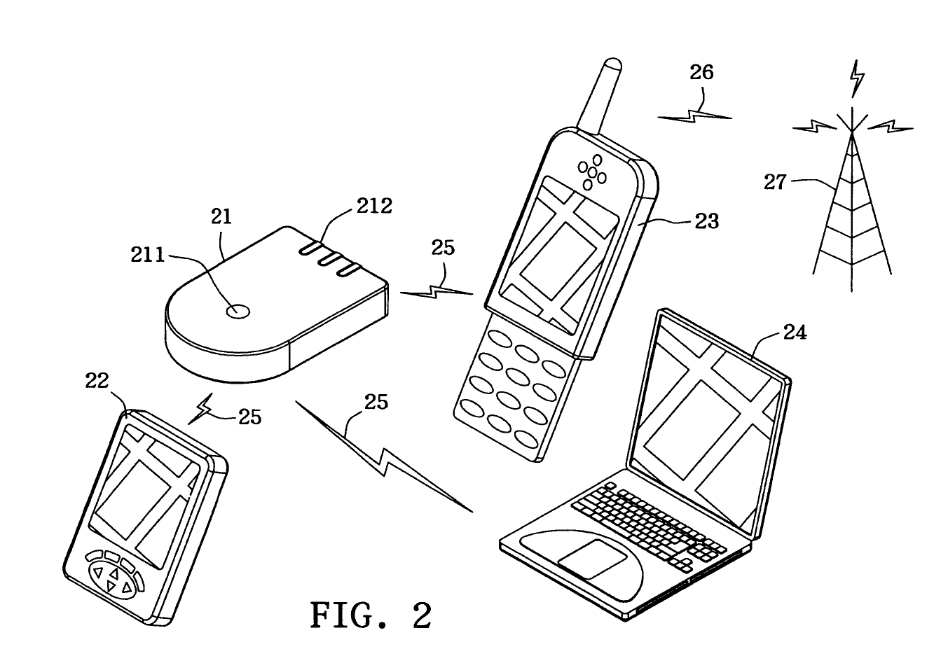

FIG. 2 is a schematic diagram of a GPS positioner having a rescue call function and its applied system as put forth in the present invention. A GPS positioner 21 is equipped with a Bluetooth communication interface. Given the transmission method of a Bluetooth communications protocol 25, it is feasible to browse and find out a present location with a personal digital assistant (PDA) 22, a notebook 24 or a smart phone 23 also having a Bluetooth communication interface. Furthermore, the GPS positioner 21 is also equipped with an emergency button 211, so that a driver or passenger may press the emergency button 211 to seek rescue whenever an emergency happens during transportation. In such a situation, with the Bluetooth communications protocol 25, a rescue request message is sent to the smart phone 23 matched in advance, and then the smart phone 23 sends the rescue request message to a base station 27 through a default wireless communications protocol 26. The wireless communications protocol 26 can be GSM, CDMA, PHS or any other protocol, sending rescue request messages in the form of short messages or by dialing an emergency phone number or by any other possible communication means. Moreover, a status indicator 212 is installed on the GPS positioner 21, and is intended to indicate a “positioned” or “not positioned” status.

The GPS positioners 21 are divided into two types of specifications according to its purposes, namely C/A code and P code. The C/A code is less precise and is mostly used by the private sector. The P code is more precise and is adopted by the military. The major function of GPS positioners 21 is to track positioning satellites and receive navigation signals transmitted by the positioning satellites. Their positioning method is as follows: figure out the distance between the GPS positioner 21 and a satellite in the light of the received position of the satellite and by means of complicated calculation based on the observation and measurement of satellite signals, and eventually determine the present position. Hence, the hardware inside the GPS positioner 21 is primarily a GPS positioning receiving module, whereas its software comprises programs designed to process navigation signals and calculate positions.

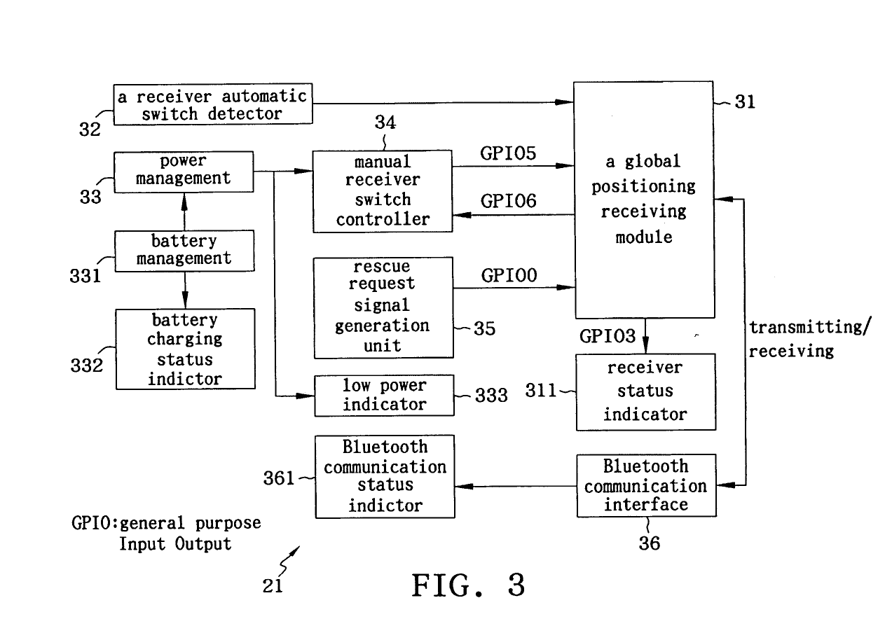

FIG. 3 is a functional block diagram about the hardware of the GPS positioner 21 put forth in the present invention, wherein the primary function of a global positioning receiving module 31 is to control other functional blocks. The receiver status indicator 311 indicates whether there is a “positioned” or “not positioned” status at the present moment. The receiver status indicator 311 is controlled by the GPIO 3 (General Purpose Input Output) of the global positioning receiving module 31. Once another GPIO 0 detects a user's pressing the emergency button 211, a rescue request signal generation unit 35 will send a rescue request signal which will then be sent to a Bluetooth communication interface 36 by the global positioning receiving module 31 before the rescue request signal reaches a default device. With a Bluetooth communications status indicator 361, users may be well aware of the operating status of the Bluetooth communication interface 36.

A receiver automatic switch detector 32 turns on or turns off the whole power supply automatically, or is controlled by a manual receiver switch controller 34 through the GPIO 5 and GPIO 6. If the power management 33 discovers that a battery management 331 is running out of power, a low power indicator 333 alerts users to the low level of power which is running out. During the charging process of the battery management 331, a battery charging status indictor 332 shows the battery power level.

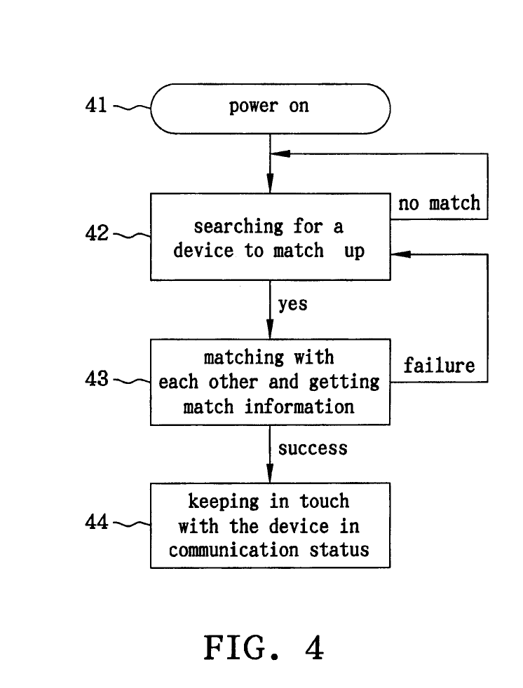

FIG. 4 is a flowchart about Bluetooth communications match for the GPS positioner put forth in the present invention. Once the global positioner 21 switches from the “off” status to the “on” status 41, it will automatically search within an effective range for a device it matches (as shown in Step 42), or, in other words, look for a device that also has a similar Bluetooth wireless communication interface. On discovery of such a device, matching begins and the fundamental data requisite for communications (for example, Bluetooth address) is acquired (as shown in FIG. 43), otherwise the search for a matching device will continue unless and until one is found. It is necessary to have a loop going back to Step 42, as an attempt on connection may abort for interference in reception or other reasons during matching and acquisition of the fundamental data required for communications. If all the aforesaid steps go smooth, the GPS positioner 21 will keep in touch with the device it matches while both are in communications status, as shown in Step 44.

The above-described embodiments of the present invention are intended to be illustrative only. Numerous alternative embodiments may be devised by persons skilled in the art without departing from the scope of the following claims.

1. A GPS positioner having a rescue call function, comprising:
a global positioning receiving module for receiving navigation signals from satellites;
a Bluetooth communication interface electrically connected to the global positioning receiving module; and
an emergency button for sending a rescue request signal through the Bluetooth communication interface.

2. The GPS positioner having a rescue call function of claim 1, wherein the rescue request signal is sent to a device also with a Bluetooth communication interface, and then the device is driven to send a rescue request message or dial an emergency phone number.

3. The GPS positioner having a rescue call function of claim 1, further comprising a rescue request signal generator for transferring an output signal of the emergency button to the rescue request signal.

4. The GPS positioner having a rescue call function of claim 1, wherein the Bluetooth communication interface automatically searches a device also with a Bluetooth communication interface after the GPS positioner is powered on.

5. The GPS positioner having a rescue call function of claim 4, wherein the Bluetooth communication interface obtains match information from the device.

6. A GPS having a rescue call function, comprising:
a GPS positioner including:
a global positioning receiving module for receiving navigation signals from satellites;
a Bluetooth communication interface electrically connected to the global positioning receiving module; and
an emergency button for sending a rescue request signal through the Bluetooth communication interface; and
at least one device with a Bluetooth communication interface.

7. The GPS having a rescue call function of claim 6, wherein the rescue request signal of the GPS positioner drives the device with a Bluetooth communication interface to send a rescue request message or dial an emergency phone number.

8. The GPS having a rescue call function of claim 6, wherein the device with a Bluetooth communication interface is a personal digital assistant, a notebook computer or a smart phone.

9. The GPS having a rescue call function of claim 6, further comprising a positioning map read by the device with a Bluetooth communication interface.
